(19) United States
(12) Patent Application Publication
(10) Pub. No.: US 2018/0202060 A1
(43) Pub. Date: Jul. 19, 2018

(54) MEASUREMENT OF TOTAL ACCELERATOR IN AN ELECTRODEPOSITION SOLUTION

(71) Applicant: ECI Technology, Inc., Totowa, NJ (US)

(72) Inventors: Michael Pavlov, Fair Lawn, NJ (US); Eugene Shalyt, Washington Township, NJ (US)

(73) Assignee: ECI Technology, Inc., Totowa, NJ (US)

(21) Appl. No.: 15/873,637

(22) Filed: Jan. 17, 2018

Related U.S. Application Data
(60) Provisional application No. 62/447,750, filed on Jan. 18, 2017.

(51) Int. Cl. C25D 3/38; G01N 27/42; C25D 21/12

(52) U.S. Cl. CPC C25D 3/38; C25D 21/12; G01N 27/42

(57) ABSTRACT

Methods for measuring total accelerator in a solution, such as an electrodeposition solution, are provided. Methods can include providing a solution containing an accelerator and one or more breakdown products of the accelerator, oxidizing the solution, and measuring the concentration of the accelerator in the solution. Methods can further include determining total accelerator based on the concentration of the accelerator in the solution.

### CROSS-REFERENCE TO RELATED APPLICATIONS

This application claims priority to U.S. Provisional App. No. 62/447,750, filed Jan. 18, 2017, the contents of which are hereby incorporated by reference in their entirety.

### BACKGROUND

Accelerators can be used as additives in electrodeposition solutions. Accelerators promote defect-free deposits that fill deep or irregular features on the surface to be treated. Accelerators are often used in conjunction with other additives, including suppressors and levelers.

For example, accelerators include organic acids, such as bis-(3-sulfopropyl) disulfide (SPS, HSO₃—CH₂—CH₂—CH₂—S—S—CH₂—CH₂—CH₂—SO₃). During the electrodeposition process, SPS is reduced to form several breakdown products. One such breakdown product is 3-mercaptopropyl sulfonate (MPS or MPSA, HSO₃—CH₂—CH₂—CH₂—SH). For reference, the chemical structures of SPS and MPS are provided in FIG. 1. The breakdown of SPS to MPS generally proceeds according to Formula 1, below:

SPS+2H⁺+2e⁻ [symbol] 2MPS (Formula 1)

Additionally, several other reactions can occur in parallel, as SPS and MPS degrade into other breakdown products. Such breakdown products included mono-ox-SPS, di-ox-SPS, mono-ox-MPS, di-ox-MPS, and propane disulfonic acid (PDS) via additional oxidation and reduction reactions or hydrolysis. A schematic of these reactions is provided in FIG. 2. Additional description of reactions involving SPS and its breakdown products is provided in Igor Volov, 2013, Copper and Copper Alloys: Studies of Additives, Columbia University Academic Commons, available at http://hdl.handle.net/10022/AC:P:15408, which is incorporated by reference herein.

MPS can provide more than double the acceleration of SPS in an acid copper electrolyte, and can have an effect on the performance of the electrodeposition solution. It is therefore important to control the equilibrium of the reaction shown in Formula 1. For example, although an electrodeposition solution can be formulated to have best performance with only SPS, only MPS, or a fixed ratio of both, the transformation of SPS to MPS, and vice versa, can alter the composition of the electrodeposition solution and cause off-specification performance.

Certain techniques can be used to control the reduction of SPS by varying reaction conditions in the electrodeposition solution, e.g., by decreasing or increasing the content of dissolved oxygen in the solution or by adding oxidants such as H₂O₂. Example techniques for adding oxidants to an electrodeposition solution containing SPS are described in U.S. Patent Publication No. 2012/0175263, which is incorporated by reference herein. Alternatively, other techniques can be used to pre-blend a reducing agent or oxidant with an organic additive, such as an accelerator. Example techniques are described in European Publication No. EP0402896, which describes the use of an oxidant within an accelerator formulation to control breakdown products from the accelerator, and is incorporated by reference herein.

However, these techniques can be insufficient to effectively control the transformation of SPS to MPS. Therefore, it can be desirable to use solution metrology to characterize the concentrations of SPS and MPS in an electrodeposition solution and from that, determine additional doses of an additive to be added to correct for degradation and provide the optimal SPS concentration. Such additional doses can be additional SPS. Therefore, metrology can be used is to determine the effective concentration of SPS, according to Formula 2, below:

Effective Concentration of SPS=Concentration of SPS g×Concentration of MPS (Formula 2)

In Formula 2, g represents the weight coefficient of MPS. The weight coefficient of MPS can vary based on the desired relative concentration of SPS and MPS. For example, the weight coefficient can depend on the process conditions and can range from very low values, e.g., when the process is dominated by SPS, to very high values, e.g., when the process is dominated by MPS.

Differing approaches can be used to characterize a blend of SPS and MPS based on a variety of techniques, such as DC and AC electrochemical measurements, HPLC, and Mass-spectroscopy. For example, certain methods for mass spectroscopy are described in U.S. Pat. No. 7,291,253, which is incorporated by reference herein. However, HPLC and mass spectroscopy are expensive and slow, and require the use of hazardous chemicals.

HPLC and mass spectroscopy methods typically characterize the absolute concentration of both SPS and MPS, allowing the end-user to apply an arbitrary MPS weight coefficient. Electrochemical methods generally fall into two groups: (1) methods that are selective to MPS and therefore have a MPS weight coefficient of close to infinity; and (2) methods that provide a measurement of total accelerator. Methods that measure total accelerator can be preferred and are practiced in industrial processes. For example, U.S. Pat. No. 6,572,753, which is incorporated by reference herein, provides additional description regarding example methods for measuring total accelerator.

However, certain methods of measuring total accelerator rely on an analytical MPS weight coefficient that may not match the actual process MPS weight coefficient of MPS. Therefore, depending on the margin of error of the analytical weight coefficient, these methods can under-weigh or overweigh the effect of MPS.

### SUMMARY

The presently disclosed subject matter provides methods for the measurement of the concentration of the total accelerator in an electrodeposition solution. For example, the presently disclosed methods can be used to determine total accelerator in an acid copper electrodeposition solution. As embodied herein, methods can include measuring and monitoring the amount of total accelerator in an electrodeposition solution, e.g., an acid copper electrodeposition solution.

In certain aspects, the presently disclosed methods include measuring total accelerator in a solution. The methods can include providing a solution containing an accelerator and one or more breakdown products of the accelerator, oxidizing the solution, and measuring the concentration of the accelerator in the solution. The methods can further include determining total accelerator based on the concentration of the accelerator in the solution.

In certain embodiments, the solution can include an acid copper electrolyte. For example, the accelerator can include bis-(3-sulfopropyl) disulfide (SPS) and/or the breakdown products can include 3-mercaptopropyl sulfonate (MPS). As embodied herein, the electrodeposition solution can include SPS and MPS, where the MPS weight coefficient is ½. The oxidation of the electrodeposition solution can recombine MPS to SPS quickly, such that the measured SPS concentration approximates the effective SPS concentration, i.e., the total accelerator.

As embodied herein, the solution can be oxidized prior to measuring the SPS concentration. In certain embodiments, the solution can be oxidized by the addition of an oxidant. For example, and not limitation, the oxidant can include an oxidative gas, an oxidative halogen, a redox compound that is present at a high oxidation state, an oxygen containing compound further including other elements that are present in a high oxidation state, a peroxide compound, or a combination thereof. In certain embodiments, the oxidant can include a peroxide compound, e.g., hydrogen peroxide. The oxidant can be added to a concentration of from about 0.01 ppm to about 100 ppm, e.g., from about 0.1 ppm to about 2 ppm. Alternatively, the electrodeposition solution can be oxidized by electrochemical oxidation on the anode.

In certain embodiments, SPS concentration can be measured using electrochemical measurements. For example, SPS concentration can be measured using cyclic voltammetric stripping (CVS) analysis. As embodied herein, the measuring can be performed within 10 minutes of the oxidizing.

The description herein merely illustrates the principles of the disclosed subject matter. Various modifications and alterations to the described embodiments will be apparent to those skilled in the art in view of the teachings herein. Accordingly, the disclosure herein is intended to be illustrative, but not limiting, of the scope of the disclosed subject matter. Moreover, the principles of the disclosed subject matter can be implemented in various configurations and are not intended to be limited in any way to the specific embodiments presented herein.

### BRIEF DESCRIPTION OF THE FIGURES

FIG. 1 provides a schematic of the reduction of bis-(3-sulfopropyl) disulfide (SPS) to form the breakdown product 3-mercaptopropyl sulfonate (MPS).

FIG. 2 illustrates further reactions of SPS and MPS to form additional breakdown products.

FIG. 3 provides the results of CVS analysis in the Example, and illustrates that similar CVS results can be achieved with the addition of hydrogen peroxide for a solution that is spiked with MPS, as compared to a target solution.

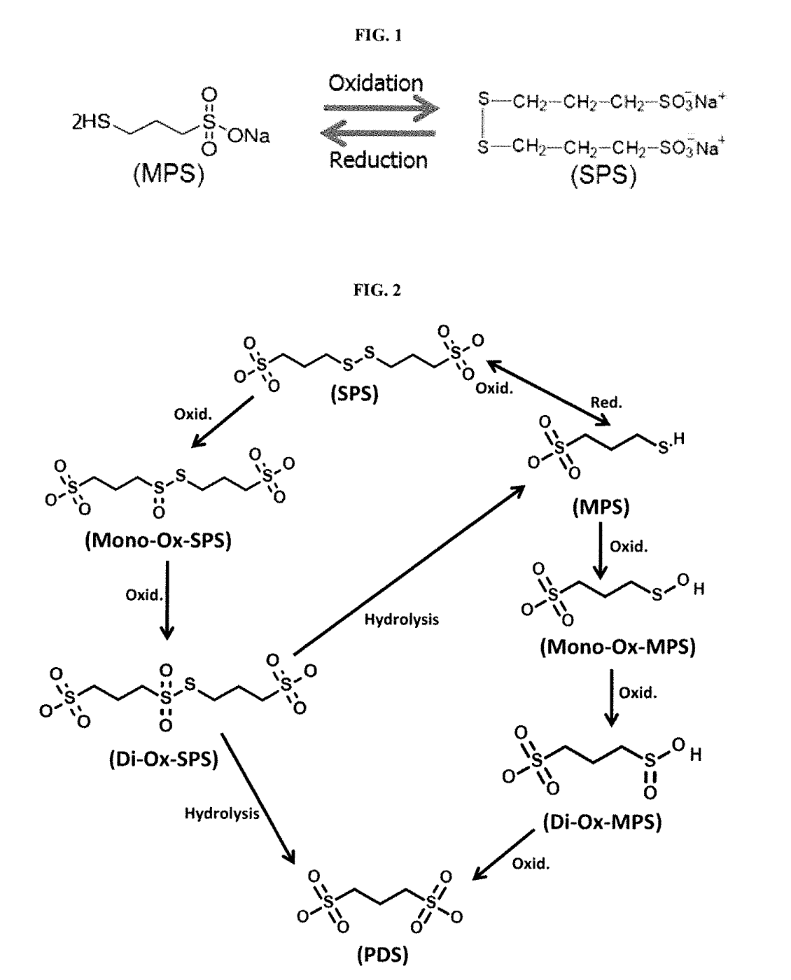

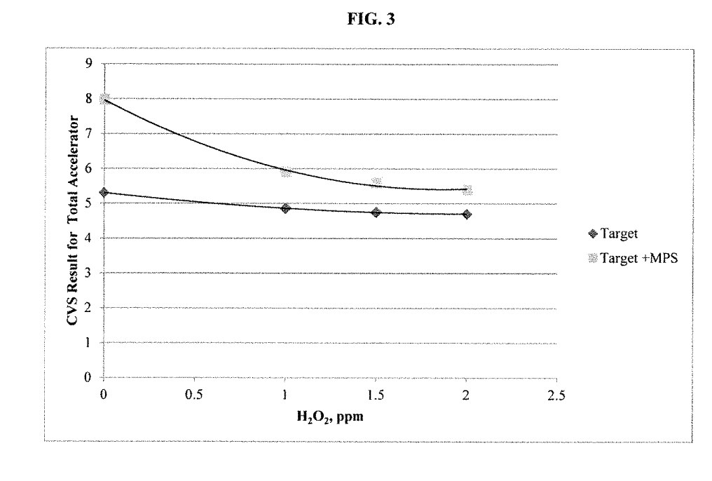

### DESCRIPTION

The present disclosure relates to methods that can be used to measure and monitor total accelerator in a solution. For example, the presently disclosed methods can be used for process control during electrodeposition, e.g., during copper electrodeposition. As embodied herein, the amount of an accelerator can be monitored during electrodeposition to optimize the amount of accelerator in the electrodeposition solution during processing. The electrodeposition solution can be an acid copper electrolyte.

As embodied herein, methods can include providing a solution containing an accelerator and one or more breakdown products of the accelerator, oxidizing the solution, and measuring the concentration of the accelerator in the solution. Methods can further include determining total accelerator based on the concentration of the accelerator in the solution. The presently disclosed methods can determine the total accelerator, i.e., the effective concentration of the accelerator when considering the effects of one or more breakdown products. For example, in solutions in which the accelerator is SPS, the SPS can break down to MPS, which has an increased accelerating effect as compared to SPS. Thus, the presently disclosed methods can measure SPS concentration and approximate the effective SPS concentration therefrom.

As described above, there is a need in the industry for improved methods of measuring the concentration of an accelerator in an electrodeposition solution, particularly for measuring total accelerator when the solution is not dominated by MPS, e.g., solutions having a MPS weight coefficient of ½.

For solutions having a MPS weight coefficient of ½, one approach to measuring total accelerator is to measure the absolute concentration of MPS and SPS and calculate the total accelerator based on the MPS weight coefficient of ½. Alternatively, electrochemical measurement can be performed to account for variable process MPS weight coefficients. Electrochemical methods are generally preferred for industrial process control. However, for an accurate measurement, the samples should be exposed to air for several hours to allow oxidation of MPS into SPS by dissolved oxygen. Recombination of MPS into SPS by dissolved oxygen can take several hours, which can be too slow for control of many industrial processes.

The presently disclosed techniques use electrochemical measurement, but are able to speed the recombination of MPS and SPS by adding an oxidant during the metrology step. Thus, the presently disclosed methods can be used to measure total accelerator for industrial process control using electrochemical measurements. In certain embodiments, the electrochemical measurement is based on cyclic voltammetric stripping (CVS) measurements.

As embodied herein, the methods include adding an oxidant during electrochemical measurement, e.g., as an analytical reagent. The oxidant is able to increase the speed of the recombination of MPS and SPS to allow for accurate measurement of total accelerator using electrochemical methods.

For example, the oxidant is able to transform MPS back to SPS according to Formula 3, below:

2MPS+oxidant→SPS (Formula 3)

The oxidant is able to transform substantially all of the MPS to SPS. Thus, the resulting solution contains only SPS. Accordingly, the result of electrochemical measurement is equal to the original concentrations of MPS and SPS, as shown in Formula 4, below:

Measured SPS=Original Concentration of SPS+½×Original Concentration of MPS (Formula 4)

Accordingly and with reference to Formula 2, above, for solutions having a MPS weight coefficient of ½, the measured SPS will be equal to the total accelerator, i.e., the effective concentration of MPS in solution. Therefore, the measurements obtained from electrochemical measurement can be used to approximate total accelerator. Moreover, as discussed above, the presence of an oxidant enables the recombination of MPS to form SPS within minutes, as opposed to the hours it can take for recombination with dissolved oxygen. For example, measurements can be obtained within 1 hour, within 30 minutes, within 20 minutes, within 10 minutes, or within 5 minutes of oxidizing the solution.

As embodied herein, the oxidant can be selected such that it promotes the fast recombination of MPS, while minimizing further oxidation of SPS. For the purpose of example, and not limitation, suitable oxidants can include: an oxidative gas, such as oxygen or ozone in pure, dissolved, or blended forms; an oxidative halogen, such as Cl₂, Br₂, and I₂; a redox compound that is present at a high oxidation state, such as Fe(III), Ce(IV), V(V); an oxygen containing compound further including other elements that are present in a high oxidation state, such as ClOy(z-), SxOy(z−), Cr x Oy(z-), AsOy(z-), and MnOy(z-); a peroxide compound, such as hydrogen peroxide; and combinations thereof. In certain embodiments, the oxidant is used at a concentration of from about 0.01 ppm to about 100 ppm, or from about 0.02 ppm to about 50 ppm, or from about 0.05 ppm to about 25 ppm, or from about 0.07 ppm to about 10 ppm, or from about 0.1 ppm to about 2 ppm. As embodied herein, an oxidant can be selected that will result in minimal further oxidation of SPS. Alternatively, rather than using an oxidant, oxidation can be performed by electrochemical oxidation on an anode.

As used herein, the term “about” or “approximately” means within an acceptable error range for the particular value as determined by one of ordinary skill in the art, which will depend in part on how the value is measured or determined, i.e., the limitations of the measurement system. For example, “about” can mean a range of up to 20%, up to 10%, up to 5%, and or up to 1% of a given value.

The presently disclosed subject matter will be better understood by reference to the following Example. The following example is merely illustrative of the presently disclosed subject matter and should not be considered as limiting the scope of the subject matter in any way.

### Example

In this example, the total accelerator of an acid copper electrodeposition solution was measured in accordance with the presently disclosed methods.

The acid copper electrodeposition solution was separated into two fractions. The first fraction was tested as the as-is solution with the target amount of SPS and MPS (“Target”). The section fraction was spiked with 0.5 ppm of MPS to simulate an aged solution (“Target+MPS”). Samples of both fractions were analyzed without the addition of an oxidant. Additionally, other samples of both fractions were mixed with different amounts of hydrogen peroxide (H₂O₂). The concentration of SPS in each sample was analyzed using cyclic voltammetric stripping (CVS). These results are provided in Table 1, below, and plotted in FIG. 3.

TABLE 1

| H₂O₂ addition, ppm | Target (ml/l) | Target + MPS (ml/l) |
|---|---|---|
| 0 | 5.308 | 7.977 |
| 1 | 4.863 | 5.897 |
| 1.5 | 4.753 | 5.603 |
| 2 | 4.705 | 5.391 |

In the absence of H₂O₂, CVS analysis registered a significantly higher total accelerator result for the solution that was spiked with MPS as compared to the target solution. However, in the presence of H₂O₂, the measured total accelerator concentration decreases such that it is only slightly higher than the target level. For all three levels of H₂O₂ the measured total accelerator was within about 500 ppm SPS, as recombined from MPS. Additionally, the oxidation rate of SPS by H₂O₂ is significantly lower than for MPS, which minimizes further oxidation of the electrodeposition solution.

In addition to the various embodiments depicted, the disclosed subject matter is also directed to other embodiments having other combinations of the features disclosed herein. As such, the particular features presented herein can be combined with each other in other manners within the scope of the disclosed subject matter such that the disclosed subject matter includes any suitable combination of the features disclosed herein. The foregoing description of specific embodiments of the disclosed subject matter has been presented for purposes of illustration and description. It is not intended to be exhaustive or to limit the disclosed subject matter to those embodiments disclosed.

It will be apparent to those skilled in the art that various modifications and variations can be made in the systems and methods of the disclosed subject matter without departing from the spirit or scope of the disclosed subject matter. Thus, it is intended that the disclosed subject matter include modifications and variations that are within the scope of the disclosed subject matter and its equivalents.

What is claimed is:

1. A method for measuring total accelerator in a solution, comprising:
providing a solution comprising an accelerator and one or more breakdown products of the accelerator;
oxidizing the solution;
measuring the concentration of the accelerator in the solution; and
determining the total accelerator based on the concentration of the accelerator in the solution.

2. The method of claim 1, wherein the solution comprises an acid copper electrolyte.

3. The method of claim 1, wherein the accelerator comprises SPS.

4. The method of claim 3, wherein the one or more breakdown products comprise MPS.

5. The method of claim 4, wherein the oxidizing transforms MPS to SPS.

6. The method of claim 1, wherein the oxidizing comprises adding an oxidant to the solution.

7. The method of claim 6, wherein the oxidant comprises an oxidative gas, an oxidative halogen, a redox compound present at a high oxidation state, an oxygen containing compound including other elements present at a high oxidation state, a peroxide compound, or a combination thereof.

8. The method of claim 7, wherein the oxidant comprises a peroxide compound.

9. The method of claim 8, wherein the oxidant comprises hydrogen peroxide.

10. The method of claim 6, wherein the oxidant is added to a concentration of from about 0.01 ppm to about 100 ppm in the solution.

11. The method of claim 10, wherein the oxidant is added to a concentration of from about 0.1 ppm to about 2 ppm in the solution.

12. The method of claim 1, wherein the oxidizing comprises electrochemical oxidation on an anode.

13. The method of claim 1, wherein the measuring comprises electrochemical measurements.

14. The method of claim 13, wherein the electrochemical measurements comprise cyclic voltammetric stripping analysis.

15. The method of claim 1, wherein the measuring is performed within 10 minutes of the oxidizing.

16. The method of claim 1, wherein the solution is an electrodeposition solution.

17. The method of claim 16, wherein the solution is an acid copper electrodeposition solution.
